(19) United States
(12) Patent Application Publication
(10) Pub. No.: US 2023/0325692 A1
(43) Pub. Date: Oct. 12, 2023

(54) SEARCH SUPPORT DEVICE AND SEARCH SUPPORT METHOD

(71) Applicant: HITACHI, LTD., Tokyo (JP)

(72) Inventors: Giada Confortola, Tokyo (JP); Mika Takata, Tokyo (JP); Toshihiko Kashiyama, Tokyo (JP)

(73) Assignee: HITACHI, LTD., Tokyo (JP)

(21) Appl. No.: 18/180,487

(22) Filed: Mar. 8, 2023

(30) Foreign Application Priority Data
Apr. 6, 2022 (JP) 2022-063302

(51) Int. Cl. G06N 5/045

(52) U.S. Cl. CPC G06N 5/045

(57) ABSTRACT

Provided is a search support device to perform a search related to a parameter representing an influence degree of a feature at high speed and with high accuracy. The search support device calculates at least one or more pieces of SHAP data indicating an influence degree of each feature in a trained model on output data output from the trained model; a process of generating compressed SHAP data, which is data obtained by compressing the SHAP data, for each of the SHAP data and storing the compressed SHAP data; verification target SHAP data which is SHAP data for output data output from the trained model by inputting input data to the trained model; a similarity between each of the calculated compressed SHAP data and the calculated verification target SHAP data, and specifies the compressed SHAP data in which the similarity with the verification target SHAP data satisfies a predetermined condition.

### CROSS-REFERENCE TO RELATED APPLICATION

This application claims priority pursuant to Japanese patent application No. 2020-063302, filed on Apr. 6, 2022, the entire disclosure of which is incorporated herein by reference.

### BACKGROUND OF THE INVENTION

### 1. Field of the Invention

The present invention relates to a search support device and a search support method.

### 2. Description of Related Art

In the field of machine learning, the use of explainable artificial intelligence (XAI) has progressed. The XAI is AI that not only outputs data with an AI model (trained model), but also enables a human to understand a process of the AI until the data is output.

The XAI uses a shapley value indicating an influence degree of each feature on the output data. As a method of utilizing the shapley value, for example, for certain data output by a user using AI, the user searches for other past SHAP values similar to an influence degree of a feature derived from the shapley value (hereinafter, referred to as shapley additive explanations (SHAP values)), thereby interpreting the output data.

Based on such a background, US2021/117863 specification discloses a method of searching for a similarity of a SHAP value. In addition, US2019/012380 specification discloses a technique of speeding up a pattern search of a feature vector as a related technique.

### CITATION LIST

### Patent Literature

PTL 1: US2021/117863 specification
PTL 2: US2019/012380 specification

### SUMMARY OF THE INVENTION

However, since a SHAP value representing an influence degree of the feature in the AI is data based on the AI that can be essentially used for various applications, the SHAP value often has various data features, and a data amount thereof may be enormous, and thus it is not easy to achieve both the speed and accuracy of searching for the SHAP value.

The invention was made in view of such a situation, and an object of the invention is to provide a search support device and a search support method capable of performing a search related to a parameter representing an influence degree of a feature at high speed and with high accuracy.

One aspect of the invention for solving the above problems is a search support device including a processor; and a memory, in which the processor is configured to execute: a process of calculating at least one or more pieces of SHAP data that is data indicating an influence degree of each feature in a trained model on output data output from the trained model, a process of generating compressed SHAP data, which is data obtained by compressing the SHAP data, for each of the SHAP data and storing the compressed SHAP data in the memory, a process of calculating verification target SHAP data which is SHAP data for output data output from the trained model by inputting input data to the trained model, and a process of calculating a similarity between each of the calculated compressed SHAP data and the calculated verification target SHAP data, and specifying the compressed SHAP data in which the similarity with the verification target SHAP data satisfies a predetermined condition.

According to the invention, a search related to a parameter representing an influence degree of a feature can be performed at high speed and with high accuracy.

Configurations and effects other than those described above will be clarified by description of the following embodiments.

### BRIEF DESCRIPTION OF THE DRAWINGS

FIG. 1 is a diagram showing an example of a configuration of hardware included in a search support device according to the present embodiment and functions of the search support device.

FIG. 2 is a diagram showing an example of a SHAP matrix according to the present embodiment.

FIG. 3 is a diagram showing an example of a compressed SHAP matrix.

FIG. 4 is a diagram showing an example of a required adoption item.

FIG. 5 is a diagram showing an example of SHAP global statistics.

FIG. 6 is a diagram showing an example of tabulating information.

FIG. 7 is a diagram showing an example of hardware information.

FIG. 8 is a diagram showing an example of system constraint.

FIG. 9 is a diagram showing an outline of a process performed by the search support device.

FIG. 10 is a flowchart showing an outline of a learning phase.

FIG. 11 is a flowchart showing details of a threshold value determination process.

FIG. 12 is a diagram showing an example of a corrected SHAP matrix generated by the threshold value determination process.

FIG. 13 is a flowchart showing details of a compressed matrix creation process.

FIG. 14 is a flowchart showing an example of an inference phase.

FIG. 15 is a flowchart showing details of a similarity calculation process.

FIG. 16 is a diagram showing an example of a process in the similarity calculation process.

FIG. 17 is a diagram showing an example of a SHAP importance related information input screen.

FIG. 18 is a diagram showing an example of a compressed SHAP matrix confirmation screen.

FIG. 19 is a diagram showing an example of a similar record display screen.

### DESCRIPTION OF EMBODIMENTS

A search support device and a search support method according to the present embodiment will be described with reference to the drawings.

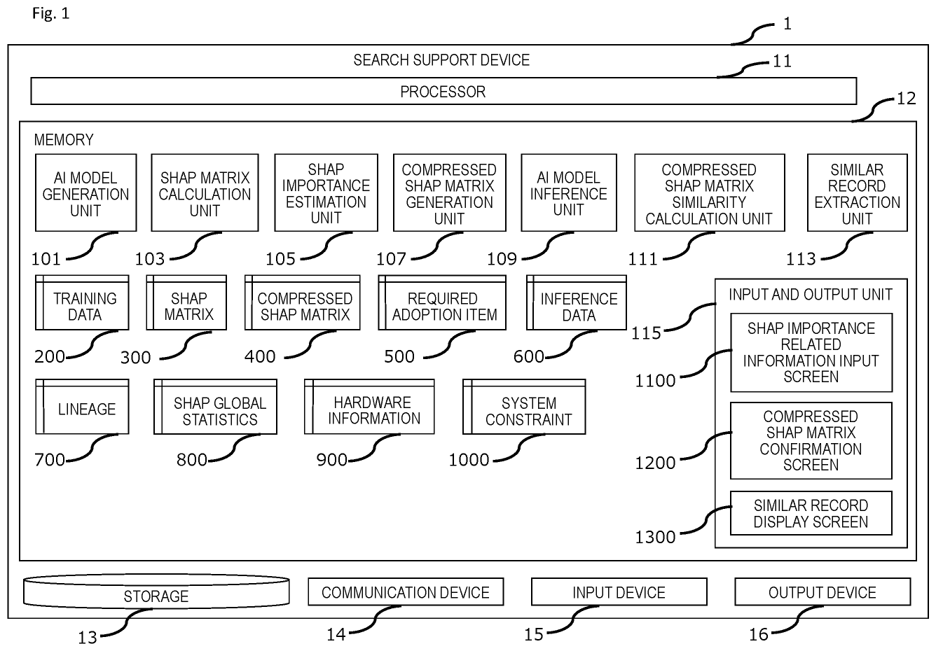

FIG. 1 is a diagram showing an example of a configuration of hardware included in a search support device 1 according to the present embodiment and functions of the search support device 1.

The search support device 1 includes: a processor 11 such as a central processing unit (CPU), a digital signal processor (DSP), a graphics processing unit (GPU), or a field-programmable gate array (FPGA); a memory 12 which is a storage device such as a read only memory (ROM), or a random access memory (RAM); a storage 13 which is a storage device such as a hard disk drive (HDD), and a solid state drive (SSD); a communication device 14 implemented by such as a network interface card (NIC), a wireless communication module, a universal serial interface (USB) module, or a serial communication module; an input device 15 implemented by a mouse or a keyboard; and an output device 16 implemented by such as a liquid crystal display or an organic electro-luminescence (EL) display.

The search support device 1 includes functional units including an AI model generation unit 101, a SHAP matrix calculation unit 103, a SHAP importance estimation unit 105, a compressed SHAP matrix generation unit 107, an AI model inference unit 109, a compressed SHAP matrix similarity calculation unit 111, a similar record extraction unit 113, and an input and output unit 115.

The AI model generation unit 101 creates a trained model by performing machine learning using training data. The AI model generation unit 101 creates a plurality of types of trained models in which types of input data are the same but types of output data are different. In the present embodiment, the trained model may be referred to as artificial intelligence (AI).

The trained model of the present embodiment uses attribute information (for example, age, sex, examination data) related to health of a certain patient as input data, and outputs (predicts), as a predicted value, future health condition (for example, risk of disease and risk of nursing care) of the patient. Each trained model outputs the health condition of the patient at a different future time point as the predicted value. Such input and output data of the trained model is an example, and is not intended to limit the scope of the invention.

When each trained model outputs an output value, the SHAP matrix calculation unit 103 calculates an influence degree of each feature that affects the output value, based on an algorithm of shapley additive explanations (SHAP). The influence degree is a value based on a shapley value. A set of the influence degree (hereinafter referred to as SHAP value) is stored as a SHAP matrix 300 (hereinafter also referred to as a SHAP matrix) to be described later.

The SHAP importance estimation unit 105 estimates importance of each SHAP value in the SHAP matrix.

The compressed SHAP matrix generation unit 107 creates compressed SHAP data (a compressed SHAP matrix 400 to be described later), which is data obtained by compressing the SHAP matrix, based on an estimation result in the SHAP importance estimation unit 105.

The AI model inference unit 109 outputs a predicted value by inputting input data designated by the user to each trained model. The output value is stored in inference data 600.

The compressed SHAP matrix similarity calculation unit 111 calculates a similarity between each compressed SHAP matrix created in the past and the compressed SHAP matrix for the output value output by the AI model inference unit 109.

The similar record extraction unit 113 extracts information on a feature associated with the compressed SHAP matrix having the highest similarity and created in the past, or the like.

The input and output unit 115 displays various types of information on a screen of the output device 16 and receives input of information from the user via the input device 15. The input and output unit 115 displays, for example, a SHAP importance related information input screen 1100, a compressed SHAP matrix confirmation screen 1200, and a similar record display screen 1300.

The SHAP importance related information input screen 1100 is a screen that receives input of a parameter for creating the compressed SHAP matrix from the user. The compressed SHAP matrix confirmation screen 1200 is a screen that displays the SHAP matrix and the compressed SHAP matrix created therefrom. The similar record display screen 1300 is a screen that displays information on a feature extracted by the similar record extraction unit 113.

Next, the search support device 1 stores data including training data 200, the SHAP matrix 300, the compressed SHAP matrix 400, a required adoption item 500, the inference data 600, lineage 700, SHAP global statistics 800, hardware information 900, and system constraint 1000.

The training data 200 is input data used to generate the trained model. The training data 200 includes one feature or a plurality of features (data item), values of the features, and label data (data to be output).

The SHAP matrix 300 is data in which a plurality of SHAP values are stored. The SHAP matrix includes a row of “case” set for each execution (output of the output value) of the trained model and a column of values of features related to the trained model in the case.

### SHAP Matrix

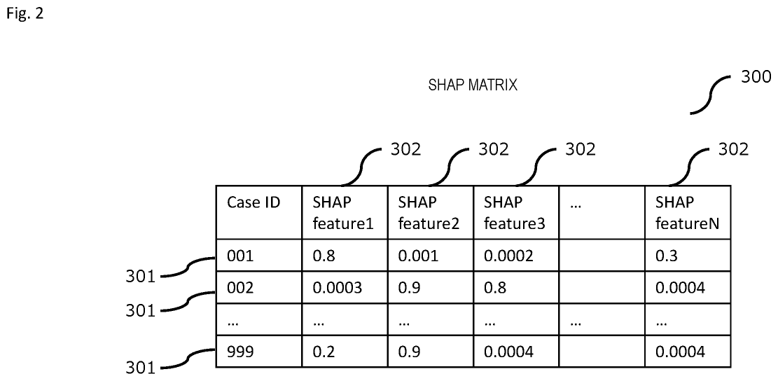

FIG. 2 is a diagram showing an example of the SHAP matrix 300 according to the present embodiment. The SHAP matrix 300 has a row 301 indicating each case and a column 302 of values of each feature in each case. The value of each feature indicates an influence degree on output data output from the trained model. The value of the feature is, for example, any value of 0 or larger and 1 or smaller.

The compressed SHAP matrix 400 shown in FIG. 1 is compressed data obtained by deleting information on a part of features of the SHAP matrix.

### Compressed SHAP Matrix

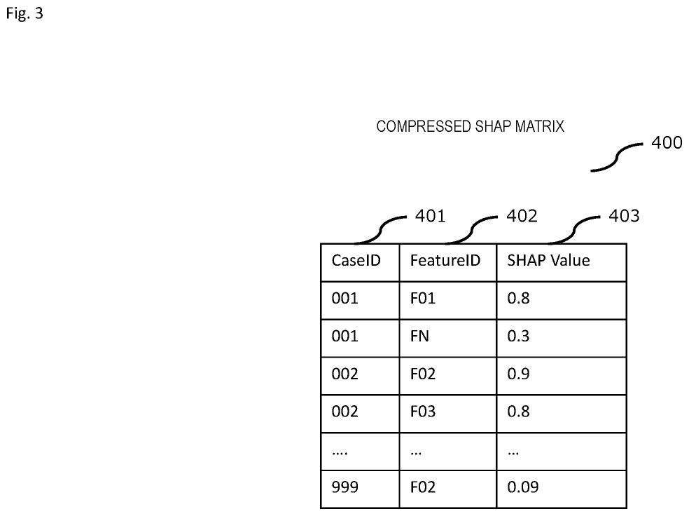

FIG. 3 is a diagram showing an example of the compressed SHAP matrix. The compressed SHAP matrix 400 includes one or more rows of data, and each row includes three data items including a case ID 401, a feature ID 402 which is an identifier of one item of the feature in the case, and a feature value 403 of the item.

The required adoption item 500 shown in FIG. 1 is data in which a required adoption item, which is a feature that is always necessary in the compressed SHAP matrix, is stored. The required adoption item 500 is set for each project of the user.

### Required Adoption Item

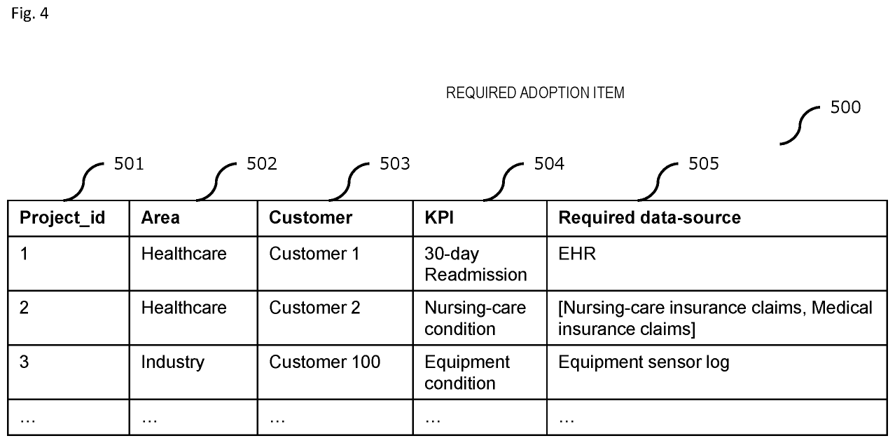

FIG. 4 is a diagram showing an example of the required adoption item 500. The required adoption item 500 includes data items including a project ID 501 in which an ID of a project set by a user to achieve a predetermined business goal using the trained model is set, an area 502 in which a business area to which the project belongs is set, a customer 503 in which information on an object person (for example, a name of the customer) of the project is set, a KPI 504 (corresponding to a type of an output value of the trained model) in which an evaluation index (in the present embodiment, which is the KPI) indicating a goal to be achieved is set, and a required data-source 505 in which the items required to be adopted in the trained model related to the project are set. Data contents of the required adoption item 500 are set in advance by the user, for example.

The inference data 600 shown in FIG. 1 is data of each output value (predicted value) obtained by inputting input data (input data and training data designated by the user) to the trained model.

The lineage 700 stores information (for example, information on a threshold value to be described later) related to a case in which the prediction is valid among cases in which the output value (predicted value) is obtained by inputting the input data to each trained model.

The SHAP global statistics 800 are data in which execution results (predicted results) of the trained model are accumulated.

### SHAP Global Statistics

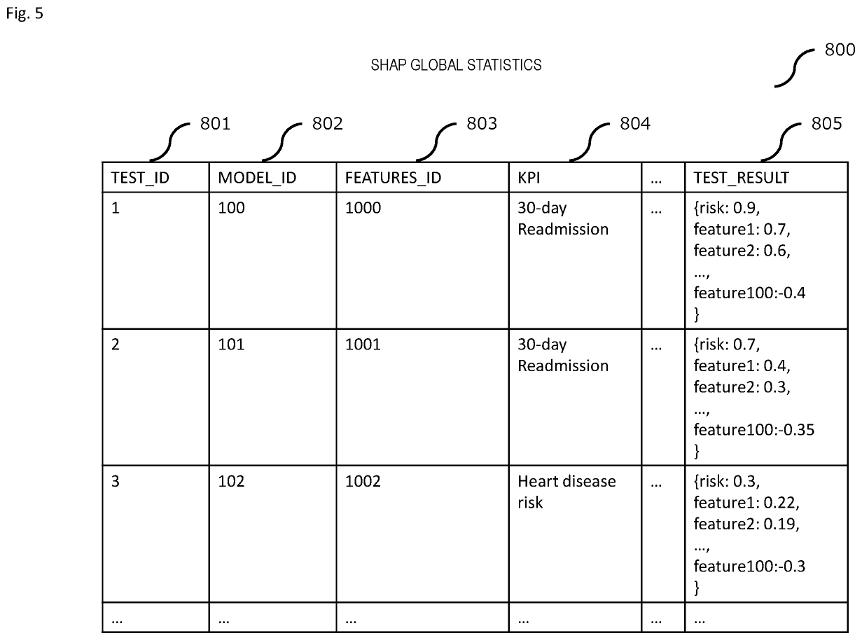

FIG. 5 is a diagram showing an example of the SHAP global statistics 800. The SHAP global statistics 800 include data items including a test ID 801 in which an ID of a performed prediction is set, a model ID 802 in which an ID of the trained model used for the prediction is set, a feature ID 803 in which information on an object person (patient or the like) of the prediction is set, a KPI 804 (corresponding to a type of an output value of the trained model) in which an evaluation index related to the prediction is set, and a test result 805 in which data related to the prediction is set. In the test result 805, an output value of the trained model related to the object person and one or more SHAP values corresponding to the output value are set.

In the present embodiment, tabulating information 850 obtained by tabulating contents of the SHAP global statistics 800 is used.

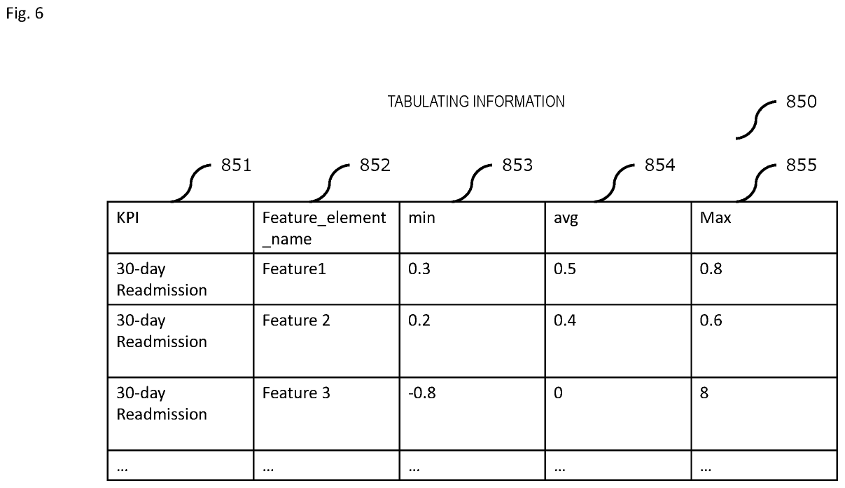

FIG. 6 is a diagram showing an example of the tabulating information 850. The tabulating information 850 includes data items including a KPI 851 in which an evaluation index (a type of the output value) is set, a feature-element name 852 in which a name of a feature related to the evaluation index is set, a minimum value 853 in which a minimum value of the feature is set, an average value 854 in which an average value of the feature is set, and a maximum value 855 in which a maximum value of the feature is set.

The hardware information 900 shown in FIG. 1 is data related to a state of the hardware of the search support device 1. The system constraint 1000 is data related to constraints on the hardware of the search support device 1 when the compressed SHAP matrix to be described later is created. The system constraint 1000 is created based on the hardware information 900.

### Hardware Information

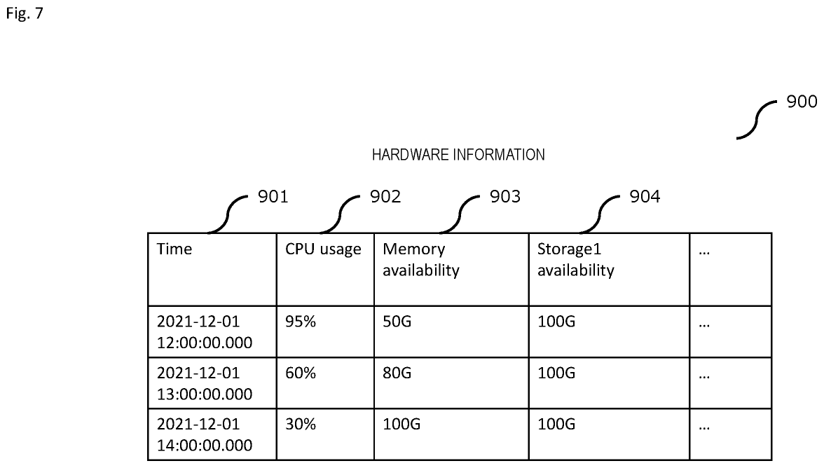

FIG. 7 is a diagram showing an example of the hardware information 900. The hardware information 900 includes data items including a time 901 in which a time (timing) at which data is acquired is set, CPU usage 902 in which usage of the CPU 11 of the search support device 1 at that time is set, memory availability 903 in which an available amount of the memory 12 of the search support device 1 at that time is set, and storage availability 904 in which an available amount of the storage 13 of the search support device 1 at that time is set. The hardware information 900 is updated as needed by a predetermined hardware monitoring program.

### System Constraint

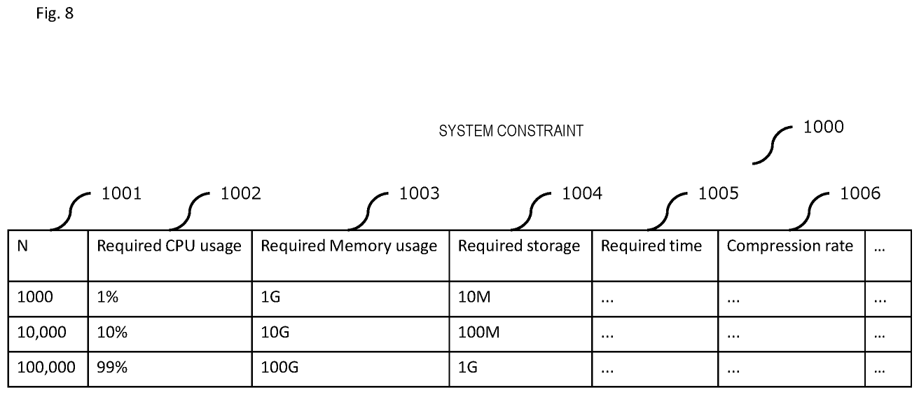

FIG. 8 is a diagram showing an example of the system constraint 1000. The system constraint 1000 includes data items including the number of pieces of data 1001 in which a condition of the SHAP matrix which is a source of the compressed SHAP matrix (in the present embodiment, a length of a column of the SHAP matrix) is set, required CPU usage 1002 in which usage of the CPU necessary for creating the compressed SHAP matrix from the SHAP matrix of the condition is set, required memory usage 1003 in which usage of the memory necessary for creating the compressed SHAP matrix from the SHAP matrix of the condition is set, a required storage 1004 in which a capacity of a storage device necessary for creating the compressed SHAP matrix from the SHAP matrix of the condition is set, a required time 1005 in which a time predicted to be necessary for creating the compressed SHAP matrix from the SHAP matrix of the condition is set, and a compression rate 1006 of the compressed SHAP matrix achieved under the condition (compression rate with respect to the original SHAP matrix).

In the present embodiment, the search support device 1 creates the system constraint 1000 based on the hardware information 900. For example, the search support device 1 calculates correlation between the length of the compressed SHAP matrix, a hardware configuration, a creation time, and the compression rate based on each compressed SHAP matrix created in the past, the hardware information 900 at the creation time, the time required to create the compressed SHAP matrix, and the compression rate of the compressed SHAP matrix using a predetermined algorithm (regression analysis, machine learning, or the like), and sets the calculated correlation in each record of the system constraint 1000. In addition, the user may perform a compression test on the SHAP matrix using the search support device 1 in advance and input the result to the system constraint 1000.

In the present embodiment, the length of the column of the SHAP matrix is set in the number of pieces of data 901, but other conditions such as a length of the row may be set. The creation method and data items of the system constraint 1000 described here are examples, and the invention does not particularly limit the creation method and the data items.

Functions of the functional units of the search support device 1 described above are implemented by reading and executing a program stored in the memory 12 or the storage 13 by the processor 11. The program may be recorded and distributed, for example, in a recording medium. All or a part of the search support device 1 may be implemented by using a virtual information processing resource provided by using a virtualization technique, a process space separation technique, or the like, for example, as in a virtual server provided by a cloud system. All or part of the functions provided by the search support device 1 may be implemented by, for example, a service provided by the cloud system via an application programming interface (API) or the like.

Next, a process performed by the search support device 1 will be described.

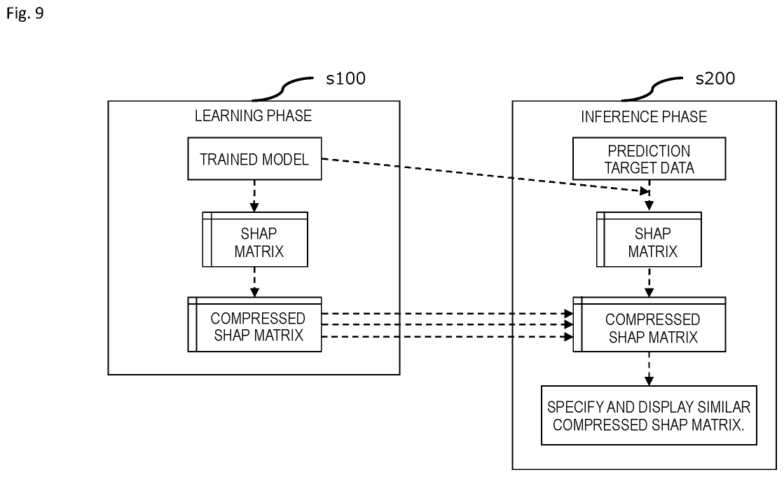

FIG. 9 is a diagram showing an outline of the process performed by the search support device 1.

First, the search support device 1 creates the trained model using the training data 200 and creates the SHAP matrix and the compressed SHAP matrix corresponding to the training data 200 (corresponding to data output by the trained model) (a learning phase s100). In this case, the search support device 1 creates a plurality of trained models that output different types of data.

On the other hand, the search support device 1 obtains an output value by inputting input data of an inference target currently performed by the user to the trained model (hereinafter, referred to as the present trained model) selected by the user from among the plurality of trained models created in the learning phase s100. The search support device 1 creates the SHAP matrix and the compressed SHAP matrix corresponding to the output value. The search support device 1 searches for the compressed SHAP matrix created in the learning phase s100, which is similar to the created compressed SHAP matrix during the current inference phase, and displays the search result on the screen (an inference phase s200).

Hereinafter, the learning phase s100 and the inference phase s200 will be described.

### Learning Phase

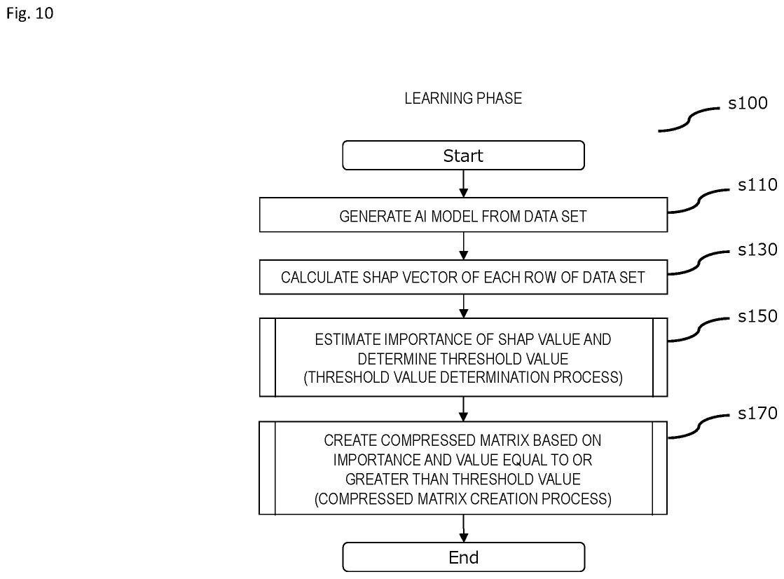

FIG. 10 is a flowchart showing an outline of the learning phase s100.

First, the AI model generation unit 101 creates the trained model (AI) (s110). For example, the AI model generation unit 101 performs machine learning using a data set (data of a plurality of items) of each case and label data (output data) corresponding to the data set as training data, thereby creating a plurality of trained models that output different types of data.

The trained model is created by executing machine learning that is based on deep learning, for example. In the present embodiment, the trained model is a neural network including an input layer for receiving the data set, one or more intermediate layers (hidden layers) that extract and output features from the data set, and an output layer that outputs a predetermined output value from the features. The neural network included in the trained model is, for example, a convolution neural network (CNN), a support vector machine (SVM), a Bayesian network, or a regression tree.

Next, the SHAP matrix calculation unit 103 creates a SHAP matrix of each feature corresponding to the output value output in the creation process of the trained model created in s110 (s130). The SHAP matrix is created, for example, by calculating marginal contribution of each feature by marginalization.

Next, the SHAP importance estimation unit 105 estimates importance of each feature in the SHAP matrix created in s130, determines a threshold value used for data compression, and further executes a threshold value determination process s150 which is a process of correcting the SHAP matrix based on the threshold value. Details of the threshold value determination process s150 will be described later.

The SHAP importance estimation unit 105 estimates the importance of each data item (feature) of the corrected SHAP matrix by calling a compressed matrix creation process s170 in relation to the corrected SHAP matrix created in the threshold value determination process s150, and creates the compressed SHAP matrix. Details of the compressed matrix creation process s170 will be described later. Then, the learning phase s100 ends.

Next, details of the threshold value determination process s150 and the compressed matrix creation process s170 will be described.

### Threshold Value Determination Process

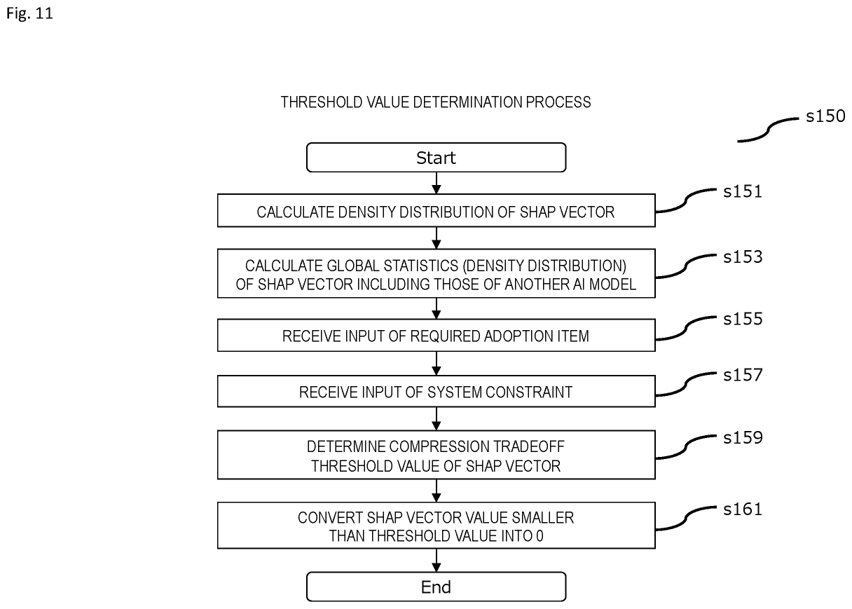

FIG. 11 is a flowchart showing details of the threshold value determination process s150. When the compressed SHAP matrix based on the SHAP matrix created in s130 is created, the SHAP importance estimation unit 105 determines a threshold value related to a value of the feature, which is a reference of compression (s151 and s153).

That is, first, the SHAP importance estimation unit 105 calculates a tentative reference by analyzing appearance frequency (density distribution) of the value of each feature of each SHAP matrix created in s130 (s151).

Specifically, the SHAP importance estimation unit 105 specifies the value (or a range of the value) of each feature of each record of the SHAP matrix and the appearance frequency (density) thereof by referring to the SHAP global statistics 800 or the tabulating information 850, and sets a value of the feature having particularly low appearance frequency as a tentative threshold value. Accordingly, the SHAP importance estimation unit 105 classifies the values into a data set in which the value of the feature is larger than the threshold value and a data set in which the value of the feature is smaller than the threshold value, and sets the tentative threshold value between the two data sets (that is, specifies a valley portion existing between two peaks related to the appearance frequency). For example, the SHAP importance estimation unit 105 sets a value of the feature having a minimum density as the tentative threshold value.

An analysis method of the density distribution described here is an example, and various types of determination methods may be adopted. The SHAP importance estimation unit 105 may receive input of the threshold value from the user.

Then, the SHAP importance estimation unit 105 adjusts the tentative threshold value calculated in s151 based on a threshold value calculated in the past and related to another type of trained model calculated in the past in s110 (s153). For example, when the threshold value related to the other type of trained model recorded in the lineage 700 is smaller than the threshold value calculated in s151, the SHAP importance estimation unit 105 sets the threshold value calculated in s151 to a lower value according to a degree of deviation between the two threshold values.

Next, the SHAP importance estimation unit 105 determines, as a data item (feature) in the compressed SHAP matrix, the required adoption item that is data item (feature) to be always adopted regardless of the threshold value calculated in s151 (s155).

For example, the SHAP importance estimation unit 105 receives input of the required adoption item from the user. In addition, for example, the SHAP importance estimation unit 105 may automatically select the required adoption item based on a history of the required adoption item designated in the past. In addition, for example, the SHAP importance estimation unit 105 may acquire the required adoption item to be adopted from a record of the required adoption item 500 having the same or similar area, object person, or KPI.

Further, when the compressed SHAP matrix is created based on the set system constraint, the SHAP importance estimation unit 105 determines a method of data compression (s157).

In the present embodiment, the SHAP importance estimation unit 105 determines a compression rate of data used to create the compressed SHAP matrix, and specifically, determines a ratio of an item to be deleted (compression of column) among items of each feature.

For example, the SHAP importance estimation unit 105 receives input of an upper limit value of the creation time of the compressed SHAP matrix. The SHAP importance estimation unit 105 acquires a current state of the hardware from the hardware information 900, and specifies a compression rate of the SHAP matrix corresponding to current hardware constraint, the upper limit value of the input creation time, and the SHAP matrix created in s130 by referring to the system constraint 1000.

A method of determining the compression rate using the system constraint 1000 described here is an example. For example, the SHAP importance estimation unit 105 may receive designation of the compression rate from the user. In addition, in the above description, the SHAP importance estimation unit 105 performs compression of a column, but may perform compression based on a row.

Then, the SHAP importance estimation unit 105 determines a final threshold value based on the threshold value determined in s153, the required adoption item determined in s155, and the compression rate determined in s157 (s159). Specifically, the SHAP importance estimation unit 105 further decreases the threshold value determined in s153 as necessary so as to satisfy the compression rate of the feature determined in s157 while excluding the required adoption item determined in s155 from compression targets.

Then, the SHAP importance estimation unit 105 creates a corrected SHAP matrix in which a value of a feature smaller than the threshold value determined in s159 is set to 0 among the features of each row and each column of the SHAP matrix created in s130 (s161). Then, the threshold value determination process s150 ends.

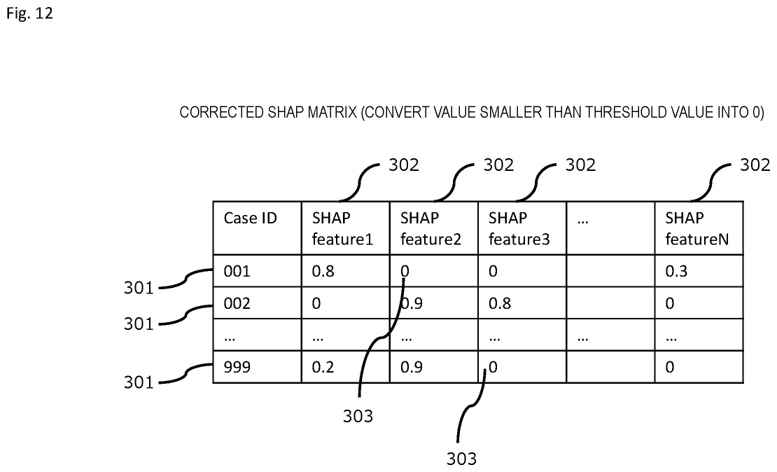

FIG. 12 is a diagram showing an example of the corrected SHAP matrix generated by the threshold value determination process s150. In the corrected SHAP matrix 300, among the elements of the SHAP matrix created in s130, a value of an element whose value is smaller than the threshold value is set to 0 (reference numeral 303).

### Compressed Matrix Creation Process

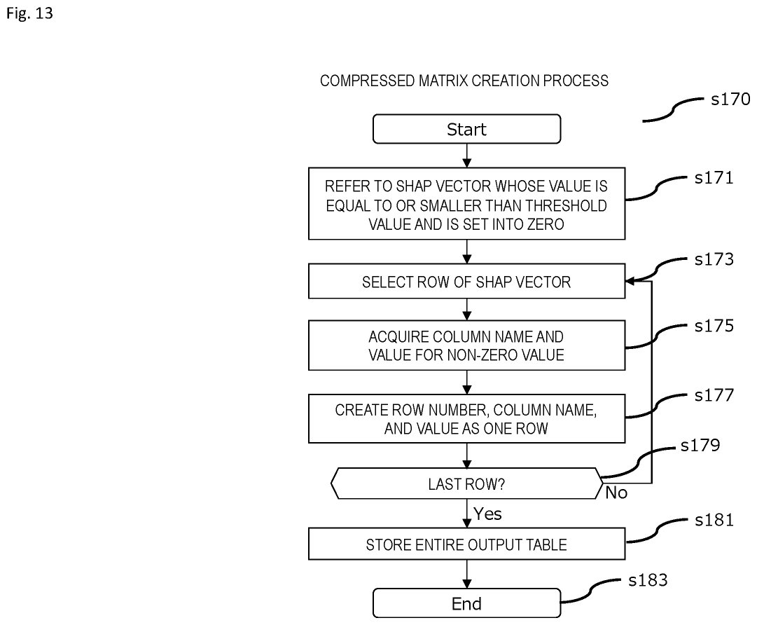

FIG. 13 is a flowchart showing details of the compressed matrix creation process s170.

The compressed SHAP matrix generation unit 107 acquires the corrected SHAP matrix created in the threshold value determination process s150 (s171).

The compressed SHAP matrix generation unit 107 selects one row of the corrected SHAP matrix acquired in s171 (s173), and acquires, for a value (value of the feature) of each column of the selected row, a feature whose value is not 0 and a data item name of the feature (s175).

The compressed SHAP matrix generation unit 107 creates a record for one row of the compressed SHAP matrix (s177). Specifically, for example, the compressed SHAP matrix generation unit 107 newly creates data in which a combination of a case ID (or row number) of the row selected in s171, the data item name acquired in s173, and the values acquired in s173 is one record, or adds the data to the existing compressed SHAP matrix.

The compressed SHAP matrix generation unit 107 confirms whether the currently selected row of the SHAP matrix is the last row (s179). When the currently selected row of the SHAP matrix is the last row (s179: Yes), the compressed SHAP matrix thus created is stored (s181), and the compressed matrix creation process s170 ends (s183). On the other hand, when the currently selected row of the SHAP matrix is not the last row (s179: No), the compressed SHAP matrix generation unit 107 repeats the process of s173 to select a next row.

Next, the inference phase s200 will be described.

### Inference Phase

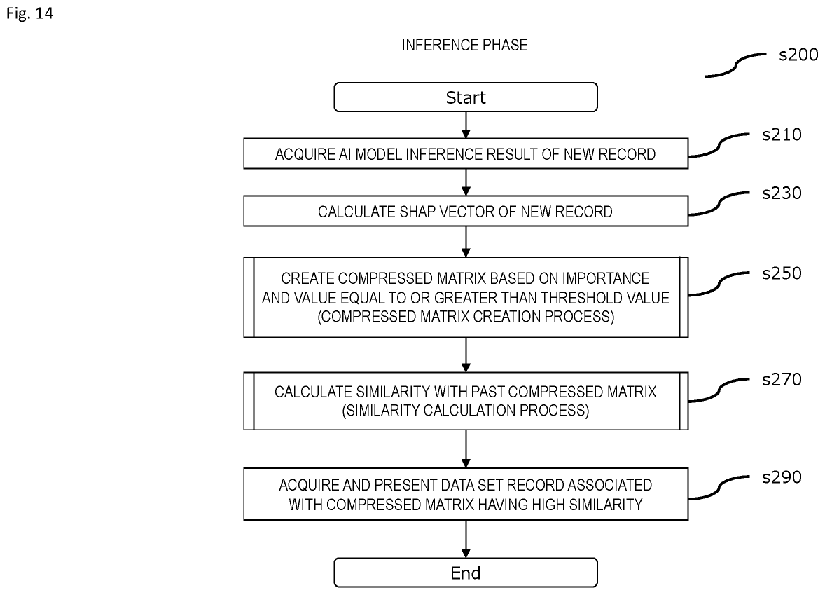

FIG. 14 is a flowchart showing an example of the inference phase s200.

The inference phase s200 is started after the user performs inference using the trained model. For example, the AI model inference unit 109 receives designation of the trained model and designation of input data (inference target data) to be input to the trained model from the user, and outputs output data (predicted value) by inputting the input data to the trained model. The inference phase s200 is started in response to this output.

First, the AI model inference unit 109 acquires the predicted value (s210).

The AI model inference unit 109 creates a SHAP matrix corresponding to the predicted value acquired in s210 according to the same algorithm as in s130 (s230).

The AI model inference unit 109 calls the compressed matrix creation process s170 in relation to the corrected SHAP matrix created in s230 to create a compressed SHAP matrix (hereinafter referred to as verification target SHAP data) for the SHAP matrix created in s230 (s250).

The AI model inference unit 109 executes a similarity calculation process s270 of calculating a similarity between the compressed SHAP matrix created in s250 and the compressed SHAP matrix of each case created in the past. Details of the similarity calculation process s270 will be described later.

The AI model inference unit 109 specifies a past compressed SHAP matrix for which a high similarity is calculated among the similarities calculated in the similarity calculation process s270. Then, the AI model inference unit 109 displays information on a case corresponding to the specified compressed SHAP matrix (for example, information on input data input to the trained model) on a screen.

Here, details of the similarity calculation process s270 will be described.

### Similarity Calculation Process

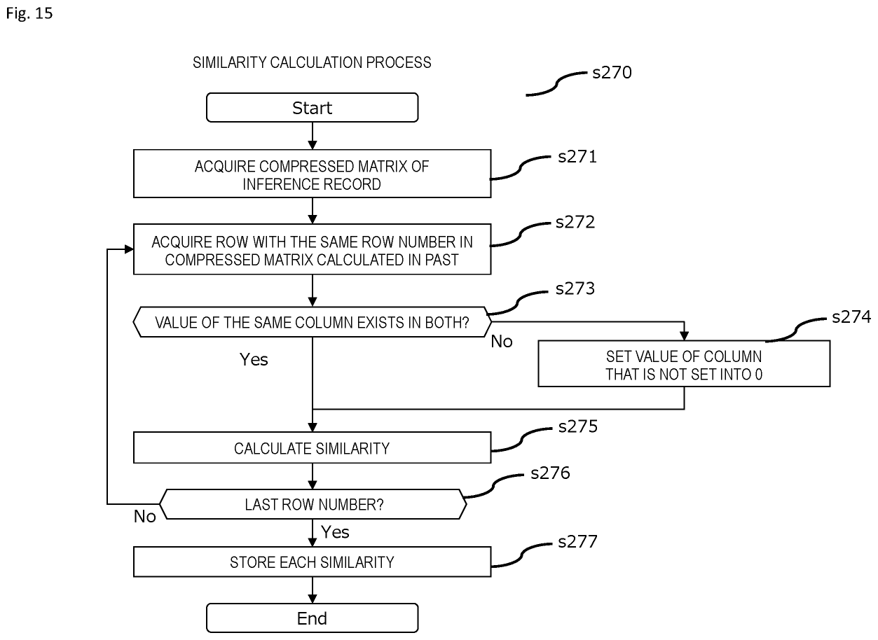

FIG. 15 is a flowchart showing details of the similarity calculation process s270.

The similar record extraction unit 113 acquires the compressed SHAP matrix created in s250 (s271).

The compressed SHAP matrix similarity calculation unit 111 acquires one piece of record data of a row in the same case as the case related to the compressed SHAP matrix acquired in s271 (hereinafter, referred to as this case, for example, data of the same project) among the rows of the compressed SHAP matrix created in the past (s272).

The compressed SHAP matrix similarity calculation unit 111 compares values of each column (each feature) of the compressed SHAP matrix acquired in s271 with values of each column (features) of the compressed SHAP matrix acquired in s273, respectively (s273).

For each feature, when the value is set in the both compressed SHAP matrices (that is, when the value (non-zero value) of the feature is set in the both compressed SHAP matrices) (s273: Yes), the compressed SHAP matrix similarity calculation unit 111 performs a process of s275 for the feature. On the other hand, when it is detected that the value (non-zero value) of the feature is not set in one of the compressed SHAP matrices (s273: No), the compressed SHAP matrix similarity calculation unit 111 (temporarily) creates a column of the feature for a compressed SHAP matrix in which the value of the feature is not set, and sets a reference value (here, 0) for the value of the feature (s274). Thereafter, the process of s275 is performed.

In s275, the compressed SHAP matrix similarity calculation unit 111 calculates, for the feature, a similarity between the compressed SHAP matrix acquired in s271 and the compressed SHAP matrix acquired in s273.

Specifically, the compressed SHAP matrix similarity calculation unit 111 sets a similarity such that a value of the similarity increases as the value of the feature of the compressed SHAP matrix acquired in s271 approaches the value of the feature of the compressed SHAP matrix acquired in s273. For example, the compressed SHAP matrix similarity calculation unit 111 sets a reciprocal of a difference between the values of the both as the similarity. A similarity calculation method described here is an example.

The compressed SHAP matrix similarity calculation unit 111 confirms whether the processes of s272 to s275 are performed for all the rows related to a case of the compressed SHAP matrix created in the past related to this case (s276). When the processes of s272 to s275 are performed for all the rows (s276: Yes), the compressed SHAP matrix similarity calculation unit 111 executes a process of s277. When there is a row for which the processes of s272 to s275 are not performed (s276: No), the compressed SHAP matrix similarity calculation unit 111 repeats processes of s272 and thereafter for the row.

In s277, the compressed SHAP matrix similarity calculation unit 111 stores similarities calculated so far (s277). Thereafter, the similar record extraction unit 113 specifies a compressed SHAP matrix which has a similarity satisfying a predetermined condition (for example, a compressed SHAP matrix, which has a similarity higher than a predetermined threshold value, or a compressed SHAP matrix up to a predetermined ranking in relation to a degree of the similarity).

Then, the compressed SHAP matrix similarity calculation unit 111 displays various types of information associated with the specified compressed SHAP matrix (for example, information on a feature of the corresponding SHAP matrix and input data for the trained model corresponding to the SHAP matrix). Then, the similarity calculation process s270 ends.

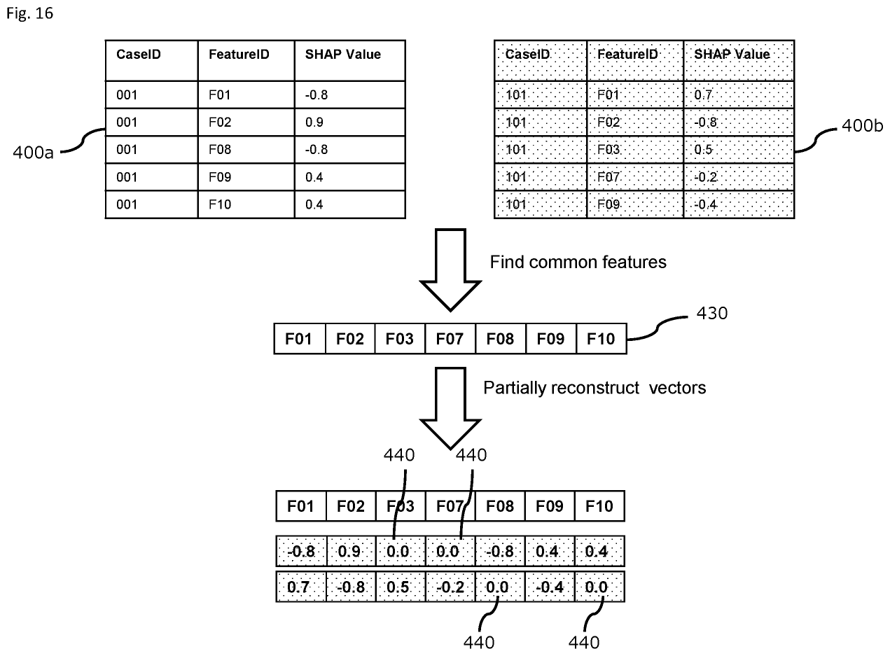

FIG. 16 is a diagram showing an example of a process in the similarity calculation process s270. As shown in FIG. 16, when there are a compressed SHAP matrix 400a related to a case “001”, which is data of rows including “F01”, “F02”, “F08”, “F09”, and “F10” as features, and a past compressed SHAP matrix 400b, which is data of rows including “F01”, “F02”, “F03”, “F07”, and “F09” as features, the similar record extraction unit 113 detects features “F01”, “F02”, “F03”, “F07”, “F08”, “F08”, “F09”, and “F10” present in the compressed SHAP matrices 400a and 400b (reference numeral 430). Then, the similar record extraction unit 113 sets, for each of the features “F03”, “F07”, “F08”, and “F10” whose value is set in only one of the compressed SHAP matrices, the value of the feature in the other of the compressed SHAP matrices into (reference numeral 440).

As described above, when values of the same item are compared with each other, in a case where the value is not set in one of the compressed SHAP matrices, the value is set into 0, thereby improving efficiency of a comparison process.

Here, a screen displayed by the search support device 1 will be described.

### SHAP Importance Related Information Input Screen

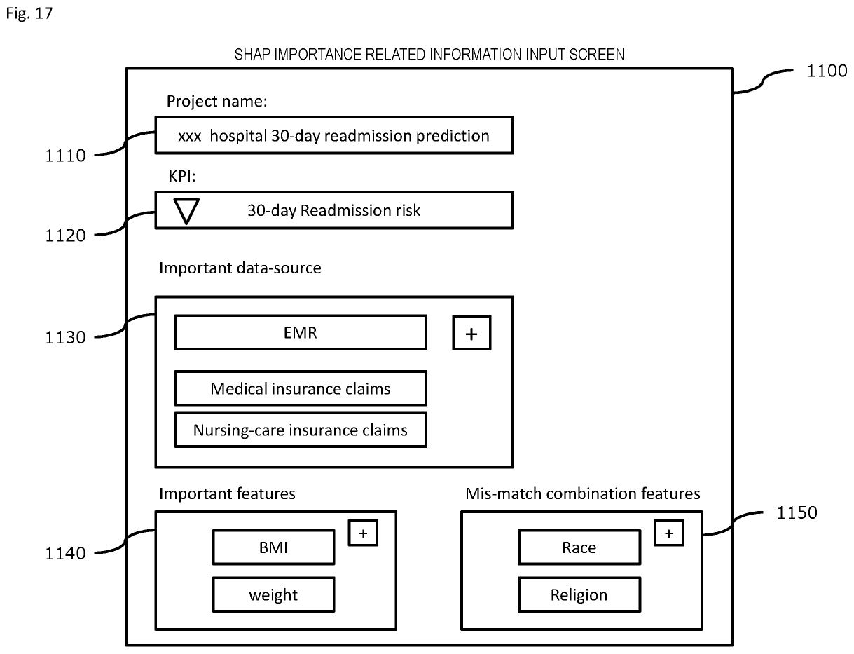

FIG. 17 is a diagram showing an example of the SHAP importance related information input screen 1100. The SHAP importance related information input screen 1100 includes a project name display field 1110 in which a name of a project is displayed, a target value input field 1120 that receives input of an evaluation index (KPI) related to the project from the user, a feature input field 1130 that receives input of a feature in the trained model from the user, and a required item input field 1140 that receives input of required adoption item from the user. As shown in a mis-match pattern input field 1150, the SHAP importance estimation unit 105 may receive designation of a combination of features to be excluded in creation of the compressed SHAP matrix.

The SHAP importance related information input screen 1100 is displayed, for example, when the user determines data to be input to the trained model or when the user inputs the required adoption item 500.

### Compressed SHAP Matrix Confirmation Screen

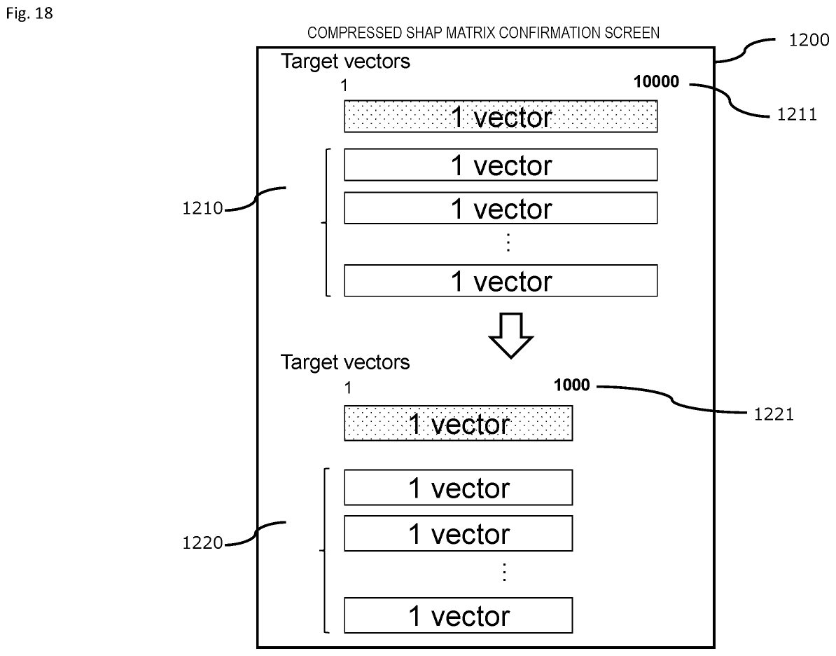

FIG. 18 is a diagram showing an example of the compressed SHAP matrix confirmation screen 1200. The compressed SHAP matrix confirmation screen 1200 includes a list display 1210 of SHAP matrices (SHAP value matrices) before compression and a list display 1220 of SHAP matrices (SHAP value matrices) after compression. Further, a length 1211 of a column of the SHAP matrices before compression (the number of features) and a length 1221 of a column of the SHAP matrices after compression (the number of features) are displayed. Accordingly, the user can confirm how much the SHAP matrix is compressed.

The compressed SHAP matrix confirmation screen 1200 is displayed, for example, when the compressed SHAP matrix is created or when input designation is received from the user.

### Similar Record Display Screen

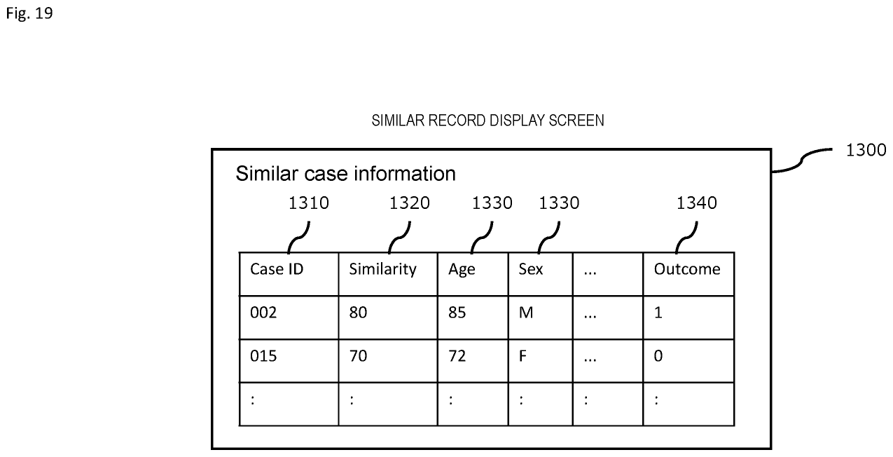

FIG. 19 is a diagram showing an example of the similar record display screen 1300. The similar record display screen 1300 displays an ID 1310 of each case determined to have a high similarity, a similarity 1320 of each case, attribute information 1330 input in each case (data input to the trained model), and output data 1340 (predicted value) output by the trained model in each case.

The similar record display screen 1300 is displayed, for example, in the similarity calculation process s270.

As described above, in the learning phase s100, the search support device 1 according to the present embodiment calculates each SHAP data for each output data output from the trained model to which the training data is input, and generates and stores compressed SHAP data for each SHAP data. On the other hand, in the inference phase s200, the search support device 1 calculates verification target SHAP data corresponding to the predicted value for the inference target data, calculates a similarity between the calculated verification target SHAP data and each compressed SHAP data, and specifies the compressed SHAP data having a similarity satisfying the predetermined condition.

That is, the search support device 1 according to the present embodiment searches for SHAP data by comparing compressed data of the SHAP data. As described above, according to the search support device 1 according to the present embodiment, a search related to SHAP data that is a parameter representing an influence degree of a feature can be performed at high speed and with high accuracy.

The search support device 1 according to the present embodiment generates the compressed SHAP data by specifying a feature to be compressed among features related to the SHAP data based on a history of each SHAP data (SHAP global statistics 800).

Specifically, the search support device 1 according to the present embodiment specifies a threshold value related to an influence degree in the SHAP data based on the history of the each SHAP data (SHAP global statistics 800), specifies the SHAP data having an influence degree equal to or less than the threshold value among values of the SHAP data as data of the feature to be compressed, and generates the compressed SHAP data by removing the specified data of the feature.

Accordingly, it is possible to specify the feature to be compressed and generate the compressed SHAP data suitable for a more accurate search.

The search support device 1 according to the present embodiment generates the compressed SHAP data by specifying the feature to be compressed among the features related to the SHAP data based on information (the hardware information 900 and the system constraint 1000) related to the hardware included in the search support device 1.

Specifically, the search support device 1 according to the present embodiment determines a compression rate of the SHAP data based on the information (the hardware information 900 and the system constraint 1000) related to the hardware included in the search support device 1, and generates the compressed SHAP data based on the determined compression rate.

Accordingly, the compressed SHAP data suitable for search can be generated according to a state of the hardware of the search support device 1 that performs the search.

In addition, the search support device 1 according to the present embodiment receives designation of a feature not to be compressed among features related to the SHAP data from the user, and generates the compressed SHAP data based on the designated feature not to be compressed.

Accordingly, an important feature essential for the search can be left in the compressed SHAP data based on knowledge (domain knowledge) of the user or the like, and an appropriate search can be performed.

When a feature existing in only one of the compressed SHAP data and the verification target SHAP data is detected during calculation of the similarity, the search support device 1 according to the present embodiment calculates the similarity between the compressed SHAP data and the verification target SHAP data by setting a value of an influence degree of the feature of the SHAP data in which the feature does not exist into a predetermined reference value (0 in the present embodiment).

Accordingly, it is possible to easily compare each feature of the compressed SHAP data with each feature of the verification target SHAP data and calculate the similarity.

The search support device 1 according to the present embodiment outputs information on the generated compressed SHAP data (compressed SHAP matrix confirmation screen 1200). Accordingly, the user can confirm how the SHAP data is compressed.

In addition, the search support device 1 according to the present embodiment displays a screen (SHAP importance related information input screen 1100) that receives the designation of the feature not to be compressed. Accordingly, the user can freely designate a feature not to be compressed.

In addition, the search support device 1 according to the present embodiment displays information related to the feature associated with the compressed SHAP data (similar record display screen 1300). Accordingly, the user can know information related to the verification target SHAP data, the inference target data, and the like.

The invention is not limited to the above embodiments, and can be implemented by using any component within a range not departing from the gist of the invention. The embodiments and modifications described above are merely examples, and the invention is not limited to these contents as long as the features of the invention are not impaired. Although various embodiments and modifications are described above, the invention is not limited to these contents. Other embodiments that are regarded within the scope of the technical idea of the invention are also included within the scope of the invention.

For example, a configuration of each functional unit described in the present embodiment is an example, and for example, a part of the functional units may be incorporated into another functional unit, or a plurality of functional units may be implemented as one functional unit.

### DESCRIPTION OF REFERENCE NUMERALS

1: search support device
11: processor
12: memory
13: storage
14: communication device
15: input device
16: output device
101: Ai model generation unit
103: SHAP matrix calculation unit
105: SHAP importance estimation unit
107: compressed SHAP matrix generation unit
109: AI model inference unit
111: compressed SHAP matrix similarity calculation unit
113: similar record extraction unit
115: input and output unit
200: training data
300: SHAP matrix
400: compressed SHAP matrix
500: required adoption item 600: inference data
700: lineage
800: SHAP global statistics
900: hardware information
1000: system constraint
1100: SHAP importance related information input screen
1200: compressed SHAP matrix confirmation screen
1300: similar record display screen

What is claimed is:

1. A search support device comprising:
a processor; and
a memory, wherein
the processor is configured to execute:
a process of calculating at least one or more pieces of SHAP data that is data indicating an influence degree of each feature in a trained model on output data output from the trained model,
a process of generating compressed SHAP data, which is data obtained by compressing the SHAP data, for each of the SHAP data and storing the compressed SHAP data in the memory,
a process of calculating verification target SHAP data which is SHAP data for output data output from the trained model by inputting input data to the trained model, and
a process of calculating a similarity between each of the calculated compressed SHAP data and the calculated verification target SHAP data, and specifying the compressed SHAP data in which the similarity with the verification target SHAP data satisfies a predetermined condition.

2. The search support device according to claim 1, wherein
the processor is configured to generate the compressed SHAP data by specifying a feature to be compressed among features related to the SHAP data based on a history of each of the calculated SHAP data.

3. The search support device according to claim 2, wherein
the processor is configured to generate the compressed SHAP data by specifying a threshold value related to an influence degree in the SHAP data based on the history of each of the calculated SHAP data, specifying data related to an influence degree equal to or less than the threshold value among the SHAP data as data of the feature to be compressed, and removing the specified data of the feature from the SHAP data.

4. The search support device according to claim 1, wherein
the processor is configured to generate the compressed SHAP data by specifying a feature to be compressed among features related to the SHAP data based on information related to hardware included in the search support device.

5. The search support device according to claim 4, wherein
the processor is configured to determine a compression rate of the SHAP data based on the information related to the hardware included in the search support device, and generate the compressed SHAP data based on the determined compression rate.

6. The search support device according to claim 1, wherein
the processor is configured to receive designation of a feature not to be compressed among features related to the SHAP data from a user, and generate the compressed SHAP data including data of the designated feature not to be compressed.

7. The search support device according to claim 1, wherein
the processor is configured to generate the compressed SHAP data as data of a combination including a name of each feature and a value of the feature.

8. The search support device according to claim 1, wherein
the processor is configured to, when a feature existing in only one of the compressed SHAP data and the verification target SHAP data is detected during calculation of the similarity, calculate the similarity between the compressed SHAP data and the verification target SHAP data by setting a value of an influence degree of the feature of the SHAP data in which the feature does not exist into a predetermined reference value.

9. The search support device according to claim 1 further comprising:
an output device configured to output information on the calculated compressed SHAP data.

10. The search support device according to claim 6 further comprising:
an output device configured to display a screen for receiving the designation of the feature not to be compressed from a user.

11. The search support device according to claim 1 further comprising:
an output device configured to display information related to a feature associated with the specified compressed SHAP data.

12. A search support method, comprising:
an information processing device executing:
a process of calculating at least one or more pieces of SHAP data that is data indicating an influence degree of each feature in a trained model on output data output from the trained model;
a process of generating compressed SHAP data, which is data obtained by compressing the SHAP data, for each of the SHAP data and storing the compressed SHAP data in the memory;
a process of calculating verification target SHAP data which is SHAP data for output data output from the trained model by inputting input data to the trained model; and
a process of calculating a similarity between each of the calculated compressed SHAP data and the calculated verification target SHAP data, and specifying the compressed SHAP data in which the similarity with the verification target SHAP data satisfies a predetermined condition.
